(19) United States
(12) Patent Application Publication
(10) Pub. No.: US 2026/0352136 A1
(43) Pub. Date: Nov. 5, 2026

(54) CONTROL SYSTEM FOR AN ELECTRIC DRIVE SYSTEM OF A HORIZONTAL DIRECTIONAL DRILLING MACHINE

(71) Applicant: Vermeer Manufacturing International BV, 's-Heer Arendskerke (NL)

(72) Inventors: Raymond Petiet, Odoorn (NL); Zach Buckley, Ankeny, IA (US); Bas Dingenouts, Oud Gastel (NL); Adam Bissen, Pella, IA (US); Drake Stadtlander, Pella, IA (US); Tyler Dorin, Pella, IA (US); Christopher Shue, Pella, IA (US)

(21) Appl. No.: 19/485,083

(22) PCT Filed: May 15, 2024
(86) PCT No.: PCT/IB2024/000234

§ 371 Date: Nov. 17, 2025

Related U.S. Application Data
(60) Provisional application No. 63/502,730, filed on May 17, 2023.

(51) Int. Cl. H02P 29/68; E21B 3/02; E21B 7/04; F15B 15/18; F15B 21/0423; G01K 13/02

(52) U.S. Cl. CPC H02P 29/68; E21B 3/02; E21B 7/046; F15B 15/18; F15B 21/0423; G01K 13/026

(57) ABSTRACT

A control system for a horizontal directional drilling machine includes a drive system having an on-board charger and an electric inverter for providing current to an electric motor. A hydraulic system includes an input shaft driven by the electric motor. A battery system includes a battery pack and a battery management system. A cooling system includes a pump, flow control devices and a coolant temperature sensor. A controller is configured to control the cooling system to provide a battery coolant to the battery pack in response to voltage, current, battery coolant temperature, battery state-of-charge, and status of the battery pack received from the battery management system. The controller is configured to control the on-board charger by providing an on-board current setpoint in response to data received from the electric inverter and the state-of-charge and the status of the battery pack.

### CROSS-REFERENCE TO RELATED APPLICATIONS

This application claims priority to and the benefit of the filing date of U.S. Provisional Application No. 63/502,730 filed May 17, 2023, which is hereby incorporated by reference herein in its entirety.

### BACKGROUND

The present arrangement relates to a horizontal directional drilling machine and methods for powering a horizontal directional drilling system with an electric motor.

### SUMMARY

A control system for a horizontal directional drilling machine includes an electric drive system including an on-board charger and an electric inverter for providing current to an electric motor; a hydraulic system including an input shaft driven by the electric motor, the input shaft arranged to drive a spindle for a drill, and a carriage; a battery system including a battery pack and a battery management system; a cooling system including a pump, flow control devices and a coolant temperature sensor; and a controller. The controller is configured to control the cooling system to provide cooling/heating flow for a battery coolant to the battery pack of the battery system in response to voltage, current, battery coolant temperature, battery state-of-charge, and status of the battery pack received from the battery management system. The controller also controls the on-board charger by providing an on-board current setpoint for the on-board charger to provide current to the electric inverter in response to data received from the electric inverter and the state-of-charge and the status of the battery pack; and control the electric inverter to drive the electric motor.

A horizontal directional drilling machine comprises: an electric drive system including an on-board charger and an electric inverter for providing current to an electric motor; a hydraulic system including an input shaft driven by the electric motor, the input shaft arranged to drive a spindle for a drill, and a carriage; a battery system including a battery pack and a battery management system; a cooling system including a pump, flow control devices and a coolant temperature sensor. A control system includes a controller configured to: control the on-board charger to provide an on-board current setpoint for the on-board charger to provide current to the electric inverter in response to data received from the electric inverter and a state-of-charge and a status of the battery pack; and control the electric inverter to drive the electric motor.

### BRIEF DESCRIPTION OF THE DRAWINGS

FIG. 1 is a diagram of a horizontal directional drilling machine having an electric drive system connected to an outside power system that includes a system controller according to some examples.

FIG. 2 is a diagram of a horizontal directional drilling system for the horizontal directional drilling machine of FIG. 1 that includes an electronic processor controller according to some examples.

FIG. 3 is a diagram of a horizontal directional drilling machine without a system controller according to some examples.

FIG. 4 is a diagram of a horizontal directional drilling machine having an electric drive system connected to an outside power system and different from the example of FIG. 3.

FIG. 5 is a diagram of a horizontal directional drilling machine having an electric drive system connected to a DC outside power system and different from the examples of FIGS. 1 and 3.

FIG. 5A is a diagram of a horizontal directional drilling machine having a separate electric motor connected to a transmission to drive a mud pump.

FIG. 6 is a diagram illustrating an example of how cooling fluids flow through various components of the cooling system of the horizontal directional drilling machine according to some examples.

FIG. 6A is a diagram illustrating another example of how cooling fluids flow through various components of the cooling system of the horizontal directional drilling machine.

FIG. 6B is a diagram illustrating another example of a cooling system that includes an electrical cooling system, a battery thermal conditioning system, and a hydraulic cooling system for a horizontal directional drilling machine.

FIG. 7 is a diagram of a horizontal directional drilling system having a pump controller that is not present in the example of FIG. 3.

FIG. 8 is a flowchart that illustrates steps executed by the controller during start-up of the horizontal directional drilling machine according to some examples.

FIG. 9 is a flowchart that illustrates a charge mode executed by the controller during operation of the horizontal directional drilling machine according to some examples.

FIG. 10 is a flowchart that illustrates a discharge mode executed by the controller during operation of the horizontal directional drilling machine powered only by the battery pack according to some examples.

### DETAILED DESCRIPTION

Before any embodiments, examples, aspects, or features are explained in detail, it is to be understood that those embodiments, examples, aspects and features are not limited in their application to the details of construction and the arrangement of components set forth in the following description or illustrated in the following drawings. Other embodiments, examples, aspects, and features are possible and are capable of being practiced or of being carried out in various ways. Also, it is to be understood that the phraseology and terminology used herein is for the purpose of description and should not be regarded as limiting.

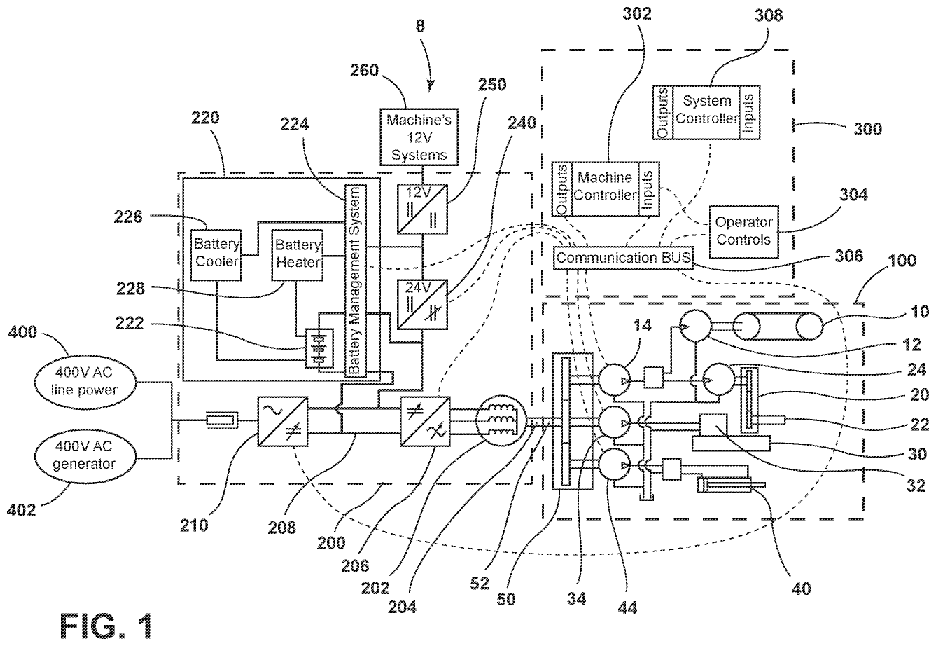

FIG. 1 illustrates an example horizontal directional drilling machine 8 that includes a mechanical system, for example hydraulic system 100. Hydraulic system 100 includes a pump drive 50, for driving three hydraulic pumps 14, 34, and 44. In the example shown, pumps 14, 34, and 44 are arranged in a stacked manner. Pump 14 provides hydraulic power for the ground drive system or the rotation system. In one example, pump 14 provides hydraulic power for one ground drive motor 12. Pump 34 provides hydraulic power for the thrust/pullback of the drill string, and pump 44 provides hydraulic power for auxiliary systems. In some examples, hydraulic pump 44 is a fixed displacement pump. In other examples, the hydraulic pump 44 is a variable displacement pump without electrical control over displacement, but instead pressure compensated.

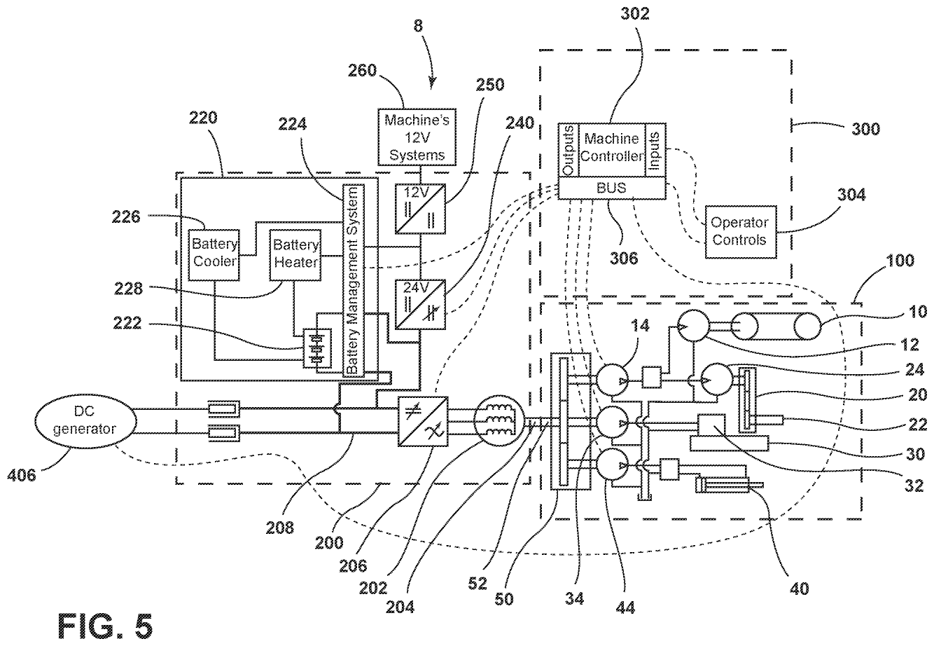

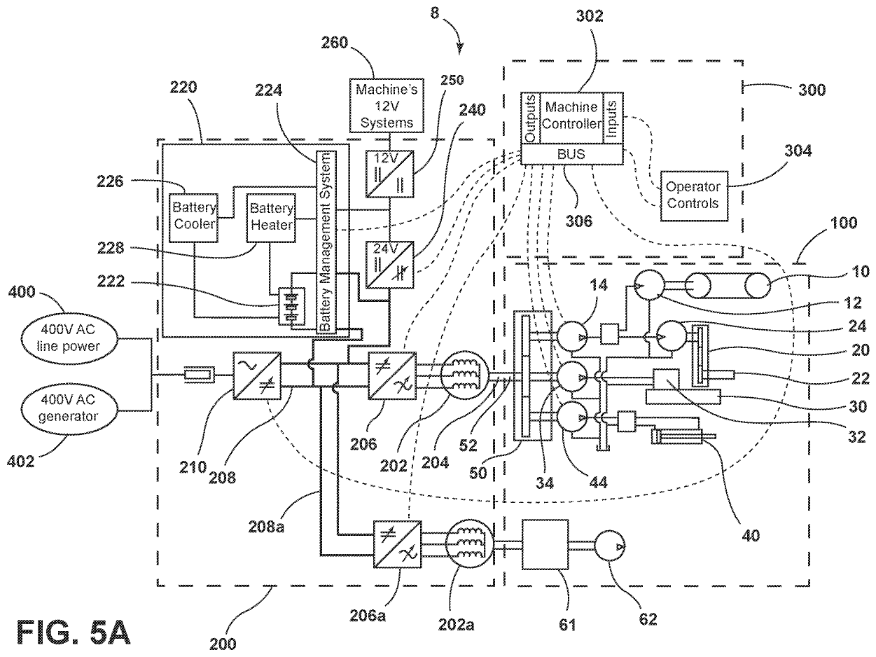

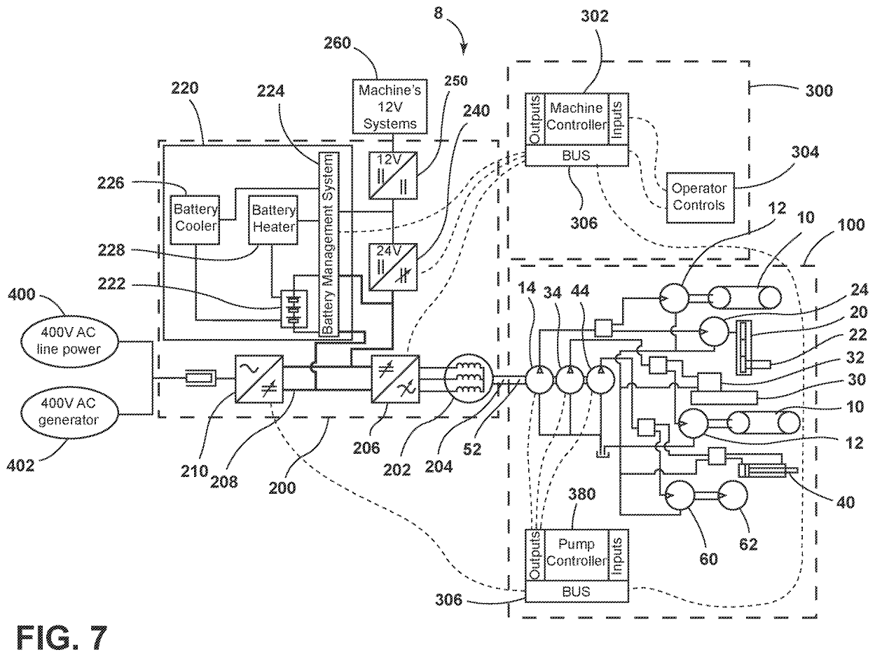

In the example of FIG. 7, the hydraulic system 100 includes a hydraulic mud pump motor 60 for powering a mud pump 62 in one example. In FIG. 5A, a second electric motor 202a drives a transmission 61 that powers a mud pump 62.

The pumps 14, 34, and 44 are typically variable displacement pumps. In the example of FIG. 1, each pump 14, 34, 44 is electrically or electromagnetically (sometimes referred to as “communicatively”) connected to a system controller 308 for example by various wired or wireless connections. The example illustrated in FIG. 1 shows the pumps 14, 34, and 44 connected to the system controller 308 via a communication bus 306. Control signals generated by the system controller 308 control the rate of flow of hydraulic fluid generated by the pumps and, thereby, control the corresponding speed and operation of the associated mechanical systems, such as hydraulic system 100. In FIG. 1, the system controller 308 is also connected to a machine controller 302 via a communication bus 306. The machine controller 302 controls the pumps 14, 34, and 44 in response to signals or data received from the system controller 308. The machine controller 302 and/or the system controller 308 also receive inputs from operator controls 304 shown in FIG. 1 to control operation of the tracks 10, the rotary drive motor 24 for the drill, the carriage 30, and other operations of the horizontal directional drilling machine 8.

In the example of FIG. 7, the pumps 14, 34, and 44 are connected to an output of a pump controller 380. The pump controller 380 is connected by the communication bus 306 with the machine controller 302. While two communication buses 306 are shown in FIG. 7 for purposes of illustration, only a single communication bus 306 is contemplated. The control system of FIG. 7 includes additional sensors and control components that are not shown. In FIG. 7, the flow from the auxiliary pump 44 can be directed to these auxiliary systems, or to drive the mud pump motor 60, that provides power to a mud pump 62.

The basic functions of the machine include propulsion of the machine itself for moving to specific locations for boring projects. The propulsion is provided by a ground drive system that includes tracks 10. In FIG. 1, a single track 10 is illustrated, while in FIG. 7 a pair of tracks 10 is illustrated, along with a pair of ground drive motors 12 to drive the ground drive system.

As shown in FIG. 1, rotation of a drill string is provided by connection to a spindle 22 that is a component of a rotary drive 20. Rotary drive motor 24 drives the rotary system, in response to receiving hydraulic power from pump 14. In some examples, there are a plurality of rotary drive motors 24. In some instances, four rotary drive motors are mounted to the rotary drive gearbox for driving rotation of a drill string.

The rotary drive 20 is propelled along a rack mounted on a carriage 30. In one configuration, a pinion gear is mounted to a drive shaft of a thrust/pullback motor 32 as shown in FIG. 1. Rotation of the pinion gear, by the thrust/pullback motor 32 causes the carriage 30 to move along the rack. In some examples, there are a plurality of thrust/pullback motors. In some instances, drills have six thrust/pullback motors mounted to the carriage 30, each having a pinion gear mounted to the output shaft and engaged with the rack gear.

The horizontal directional drilling machine 8 may include auxiliary systems such as vises that clamp a drill string to make-up or break joints between individual drill rods that comprise the drill string. Those auxiliary systems are shown in the example of FIG. 1, to be powered by a hydraulic fluid pumped by the auxiliary pump 44 that powers an actuator such as an auxiliary cylinder 40.

The horizontal directional drilling machine 8 may include other components that are not shown in FIG. 1, in order to simplify the illustration. Those components include, for example, control valves, and sensors that are connected to the control system 300. The sensors include coolant temperature sensors that determine the coolant temperature of the cooling fluids that flow through the various elements of the system including the battery pack and other elements.

The hydraulic system 100, the electric drive system 200 and the corresponding control system 300 are connected for operation. In one example, the hydraulic system 100 is connected to an electric drive system 200. The electric drive system 200 includes an electric motor 202, also referred to as an electric machine. The electric motor 202 has an output shaft 204 that is coupled to the input shaft 52 of the pump drive, illustrated in FIG. 1, or to the pump stack including hydraulic pumps 14, 34, 44 as illustrated in FIG. 7. Thus, the input shaft 52 is driven by the electric motor 202. The electric motor 202 is electrically connected to an electric inverter 206, also referred to as a liquid cooled heavy duty electric inverter. In one example, the electric inverter 206 is a first electric inverter and at least a second electric inverter is contemplated. In another example four to ten electric inverters 206 are contemplated. The number of electric inverters 206 may correspond to the number of on-board chargers 210. In another example, the electric inverter 206 is a programmable electric converter marketed by Danfoss as EC-C1200-450. In one example the electric inverter 206 has the following characteristics:
Input Voltage: 0 -850 Volts Direct Current (vdc)
Usable Power: 90 kilowatt (kW)
Additional Features:
Bidirectional energy flow
Cooling ports for coolant
Motor control
Adjustable power limits

The electric inverter 206 is communicatively connected to the system controller 308 through the communication bus 306. Other bus connections are contemplated. Through this communication bus 306, the system controller 308 is capable of setting power limits, to limit the power drawn by the electric motor 202, to monitor power drawn by the electric motor, to monitor the temperature of the electric motor, and other properties of the electric motor 202.

The electric inverter 206 is also connected to a DC power bus 208, that can also be considered a DC Intermediary Circuit. The electric inverter 206 receives power from the DC power bus 208 in the form of direct current, and converts that power to alternating current. The alternating current is provided by the electric inverter 206 to the electric motor 202 to generate a rotating magnetic field within the electric motor 202. An armature in the electric motor 202, coupled to its output shaft 204, rotates to follow the rotating magnetic field. The electric inverter 206 is configured to vary the operating characteristics of the alternating current to affect the rotational speed of the electric motor 202, and is configured to monitor the level of current to determine power being consumed by the electric motor 202. Power consumed by the electric motor 202 is, in some instances, effectively equivalent to the power transferred to the pump drive 50 or pump stack.

The DC power bus 208 is also connected to an on-board charger 210. In one example, the on-board charger 210 is a product manufactured and marketed by Meta System SPA as their model J1. FIGS. 1, 3 and 5A illustrate the on-board charger 210 connected to either a 400V alternate current (AC) line power source 400, or a 400V AC generator 402. These sources of power are expected to have operating characteristics similar enough that the on-board charger 210 can be connected to either one. Other voltages, including 440 V AC and 480 V AC, are contemplated for the line power source 400 or for the AC generator 402.

In a specific example the on-board charger 210 has the following characteristics:
Input Voltage: 3-phase 400 Volts Alternating Current (VAC)
Nominal Output Voltage: 700 VDC
Usable Power: 21 kW

In one example, a charging system capacity of 40 kW is provided by utilizing a first on-board charger, and a second on-board charger, with the specifications noted above, and arranged in parallel. Other examples are also contemplated including four, eight, or more on-board chargers 210.

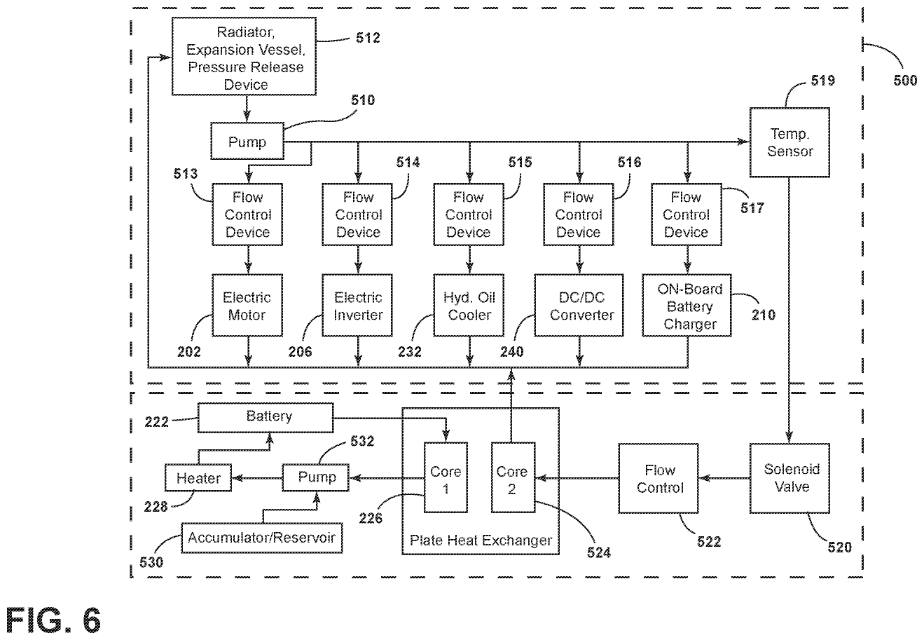

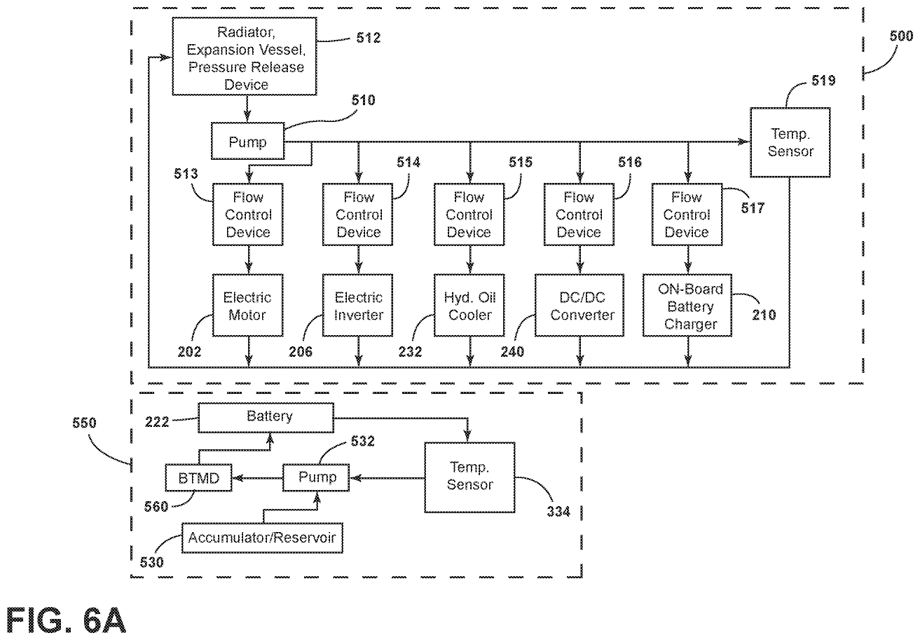

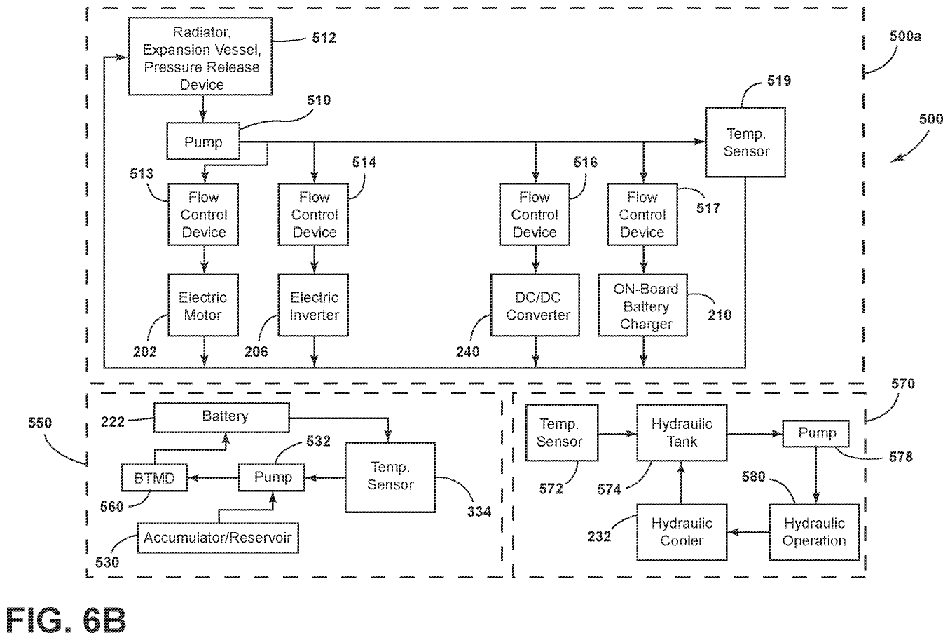

The on-board chargers 210 have cooling ports for coolant. The cooling circuit for the on-board charger 210 is integrated with the cooling circuit of the horizontal directional drilling machine 8 in a number of ways, one of which is described below with respect to FIG. 6. The on-board charger 210 is the power supply for the entire system.

The DC power bus 208 is also connected to a battery system 220 that, in one example, includes a battery pack 222, a battery management system (BMS) 224, an integrated battery cooler or heat exchanger 226, and an integrated battery heater 228. The battery management system 224 is communicatively connected to the system controller 308 via the communication bus 306. Through this connection the system controller 308 coordinates the functions of the cooling system 500 with the functions of the battery cooler 226 and battery heater 228 of the battery system 220. In one example, the battery system 220 is a product manufactured by WattAlps. In this example, the battery system 220 has the following characteristics:
Voltage: 600-800 Vdc
Usable Capacity: 17 kWh
Modules: 14 in series (48V modules)
Features:
Integrated cooling pump and fluid, a heat exchanger to transfer heat between the battery coolant and electronic coolant
Integrated heater
BMS system external to the individual modules
Built in pre-charge and contactor

The DC power bus 208 is also connected to a first DC/DC converter 240. This first DC/DC converter 240 generates an output voltage of 24 V, that is used for powering 24 volt systems of the drilling machine. The example illustrated in FIG. 1, is intended to illustrate that power for the battery cooler or heat exchanger 226 and battery heater 228 could be drawn from the output of this first DC/DC converter 240. The horizontal directional drilling machine 8 could include other 24V systems, and the battery system 220 could utilize other sources for powering the battery cooler or heat exchanger 226 and the battery heater 228. The example is intended only to illustrate one possibility.

A second DC/DC converter 250 is illustrated in FIG. 1 as being connected to the 24 Volt output of the first DC/DC converter 240, and used to provide a 12 Volt supply for other 12V systems 260 on the horizontal directional drilling machine 8. In another example, the first DC/DC converter 240 provides a voltage in a range from 14-50 V and the second DC/DC converter provides a voltage in a range from 6 to 25 V. Other voltages are contemplated.

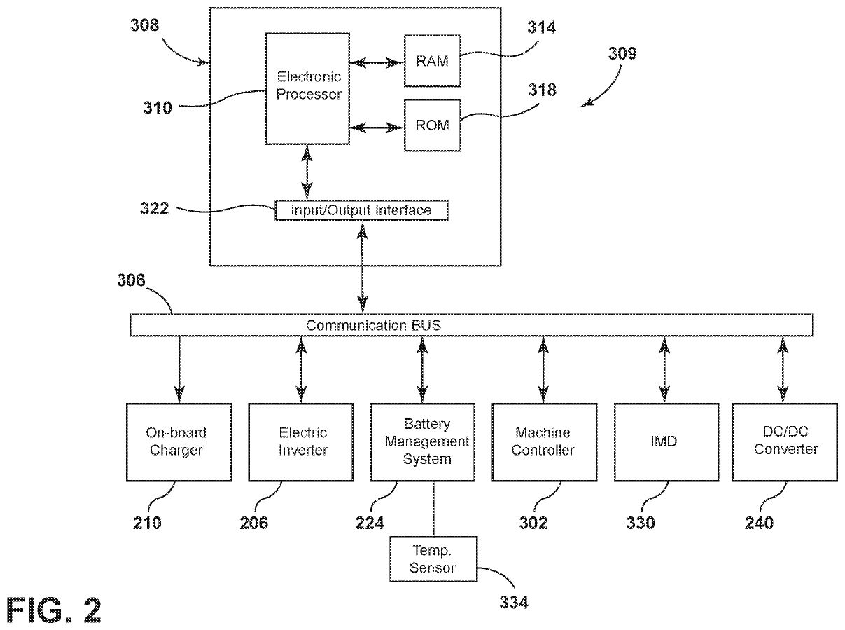

FIG. 2 illustrates a horizontal directional drilling system 309 for the horizontal directional drilling machine 8 of FIG. 1. In the example shown, the system controller 308 includes an electronic processor 310 and one or more non-transitory, computer-readable memory modules. In the example shown in FIG. 2, the system controller 308 includes a memory or non-transitory computer readable medium, for example, including a random access memory (“RAM”) module 314 and a read-only memory (“ROM”) module 318, connected to the electronic processor 310. The system controller 308 also includes an input/output (I/O) interface 322 that transmits and receives data over the communication bus 306. It should be understood that the system controller 308 can include multiple electronic processors, additional computer-readable memory, multiple I/O interfaces, and/or additional components or modules (e.g., hardware, software, or a combination thereof).

The electronic processor 310 shown in FIG. 2 receives information from the I/O interface 322 and processes the information by executing instructions for one or more software modules stored to a memory of the system controller 308, such as the read-only memory (ROM) 318. The electronic processor 310 stores information to and retrieves information from the random access memory (RAM) 314 (e.g., information received from other controllers or sensors through the communication bus 306 and information generated by modules executed by the electronic processor 310). The non-transitory computer readable memory modules of the system controller 308 include volatile memory, non-volatile memory, or a combination thereof and, in various constructions, may also store operating system software, applications/instructions data, and combinations thereof.

In one example, the electronic processor 310 provides instructions through the communication bus 306 to the machine controller 302 and the machine controller 302 controls the pumps 14, 34, and 44 of the hydraulic system 100. In another example, the electronic processor 310 of the system controller 308 is capable of directly controlling the hydraulic system 100 while receiving temperature information and other data from the machine controller 302. In one example, the machine controller 302 represents the controller for an internal combustion engine (ICE) powered horizontal directional drilling machine 8. The addition of the system controller 308 allows the substitution of an electric motor 202 and battery system 220 for an internal combustion engine while continuing to use the machine controller 302 intended for control of an internal combustion engine. Thus, a retrofit from an ICE powered horizontal directional drilling machine to an electric powered horizontal directional drilling machine is provided in an efficient manner.

Other controllers, devices, and sensors are also connected to the communication bus 306 and communicate with the electronic processor 310 of the system controller 308 as shown in FIG. 2 and elsewhere. For instance, various temperature sensors (not shown) provide temperature of the battery fluid or the temperature of the fluid of the hydraulic system to the electronic processor 310 of the system controller 308. An insulation monitoring device (IMD) 330 shown in FIG. 2 is provided to monitor insulation of the DC power bus 208 and provide a value to the system controller 308 as to the status of the insulation of the DC power bus 208 to determine operability of the battery system 220, such as determining presence of a short circuit. A battery coolant temperature sensor 334 for the battery pack 222 and/or for cooling fluid to the battery system 220 is also illustrated in FIG. 2.

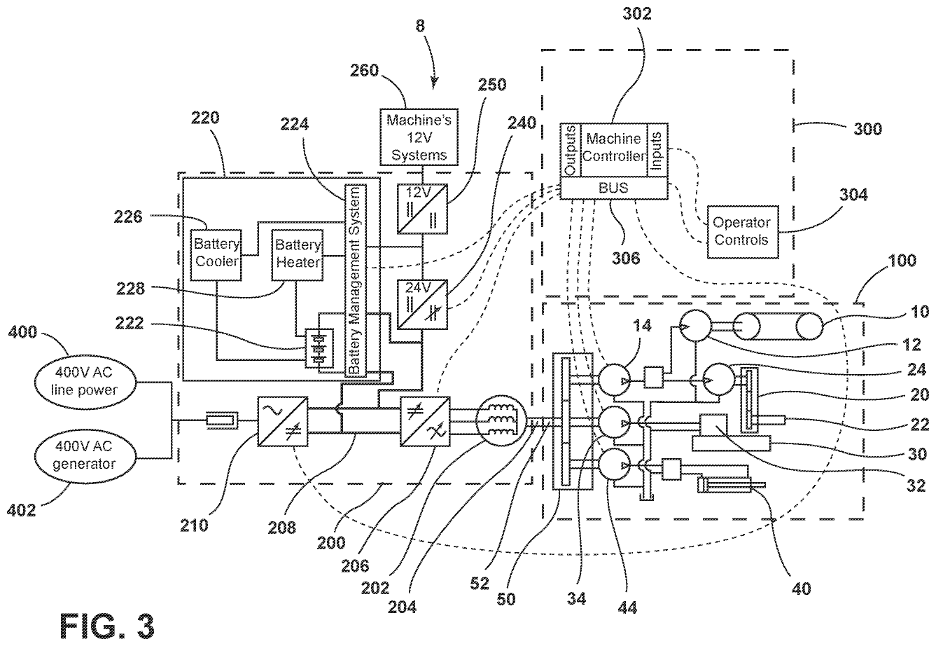

FIG. 3 illustrates the horizontal directional drilling machine as shown in FIG. 1, except that the system controller 308 is incorporated into the machine controller 302. While FIG. 3 shows the communication bus 306 connected to the machine controller 302, the communication bus 306 is a bus that extends to, and communicates with the electric inverter 206, the on-board charger 210, the battery management system 224, and the pumps 14, 34, and 44 of the hydraulic system 100 as in an example described above.

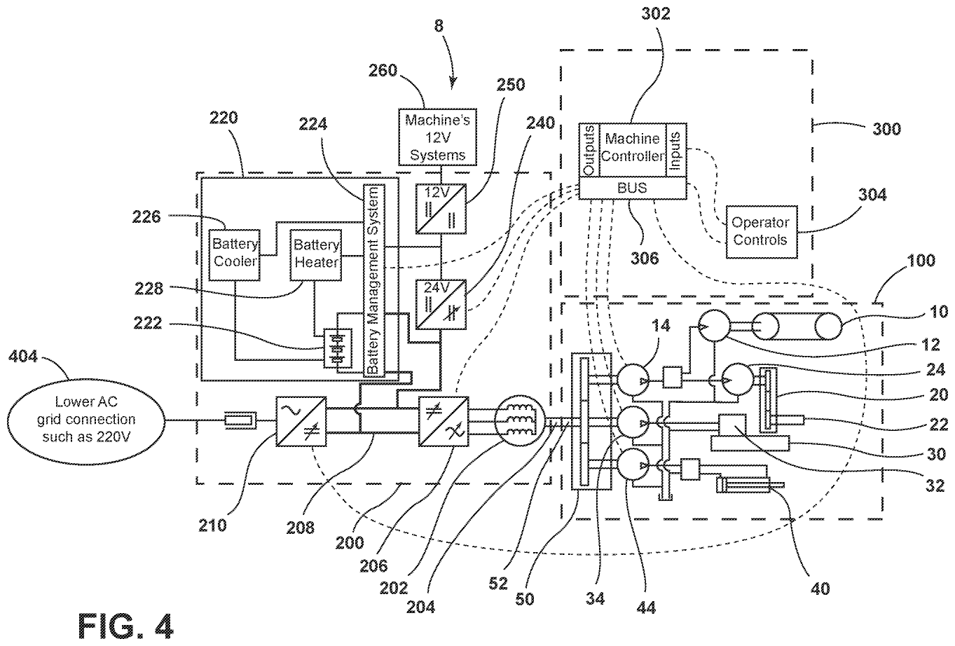

FIG. 4 illustrates the horizontal directional drilling machine as shown in FIG. 3, except that source of power is a lower power AC grid connection 404, such as a 220V connection. The on-board charger 210 is configured to enable this connection.

FIG. 5 illustrates a similar horizontal directional drilling machine, with the DC power bus 208 connected to a DC generator 406. In this example an on-board charger 210 is not required. The DC generator 406 is communicatively connected to the machine controller 302 through the communication bus 306, such as a controller area network (CAN) bus connection. Through this communication bus 306, the machine controller 302 is able to regulate the power generated by the DC generator 406 to approximately match the power being absorbed by the electric motor 202 and the electric inverter 206.

FIG. 5A illustrates a similar horizontal directional drilling machine 8 as the machine shown in FIG. 3. In this example, a second electric inverter 206a connects to the on-board charger 210 via the power bus 208a. Th power bus 208a and power bus 208 are connected and represent the same power bus in one example. The second electric inverter 206a provides power to a second electric motor 202a. The second electric motor 202a outputs power via a shaft to a mud pump transmission 61. The mud pump transmission 61 includes gears, sprockets, a timing belt, and/or a gear box in some examples. Other arrangements are contemplated. One arrangement includes a rubber timing belt having an input and an output sprocket. The mud pump transmission 61 drives the mud pump 62. Further, the second electric inverter 206a is connected to the machine controller 302 via the communication bus 306 for control of the power/electricity supplied to the second electric motor 202a. Otherwise, the arrangement shown in FIG. 5A operates in a similar manner to the arrangement shown in FIG. 3.

In one example, the second electric inverter 206a and the second electric motor 202a shown in FIG. 5A have their own cooling system separate from the cooling system 500. This arrangement allows for modularity such that a smaller or larger mud pump 62, second electric inverter 206a, and second electric motor 202a can be installed on the horizontal directional drilling machine with relative ease. Further, the number of connections is minimized. In another example, the second electric inverter 206a and second electric motor 202a are incorporated into the electric cooling system 500. The mud pump motor 60 shown in FIG. 7, in another example, has its own cooling system separate from the hydraulic system 100. In another example, the mud pump motor is incorporated into the hydraulic cooling system 570.

FIG. 6 illustrates how cooling fluids flow through various components of the cooling system 500 including a cooling system pump 510 for the basic horizontal directional drilling machine. Pump 510 is connected to a radiator, expansion vessel, and/or pressure release device 512. A coolant (for example, a water glycol mixture) is typically stored in the radiator, with the pump 510 transferring the mixture to a series of flow control devices 513, 514, 515, 516, and 517, and then to various devices including the electric motor 202, the electric inverter 206, a hydraulic (“hyd”) oil cooler 232 for cooling the hydraulic system of the machine, the DC/DC converter 240 and the on-board charger 210. The example of the cooling system 500 illustrated in FIG. 6 includes a specific flow control device 513, 514, 515, 516, and 517 for each of these various devices, so that the flow rate of coolant is controlled individually, for each device or component 202, 206, 232, 240, and 210. Alternatively, the flow rate for these devices or components 202, 206, 232, 240, 210 can be controlled by controlling the output of the pump 510.

The pump 510 shown in FIG. 6 is fluidly connected to a coolant temperature sensor 519, that measures the temperature of the coolant at the location in the cooling system 500 where the coolant is being supplied to solenoid valve 520 and flow control valve 522, that are positioned adjacent the battery pack 222. These valves 520, 522, in one example, are controlled to affect how the coolant will flow through the heat exchanger 524 to interact with the battery coolant of the battery cooler or heat exchanger 226. Battery coolant is stored in an accumulator 530. Pump 532 is controlled by the battery management system 224, and selectively pumps battery coolant through a battery heater 228, the battery pack 222, and through the battery cooler or heat exchanger 226. The pump 532 for the battery coolant is separate from the pump 510 of the cooling system 500. The battery cooler or heat exchanger 226 is positioned adjacent to the heat exchanger 524 allowing heat generated within the battery pack 222 to be transferred to the coolant of the hydraulic system 100 of the machine 8, while also maintaining separation between the machine's coolant and the battery coolant. Thus, the cooling system 500 provides cooling/heating flow for a battery coolant to the battery pack 222 of the battery system 220. The heat exchanger 524 exchanges heat between the battery coolant and the coolant for the electric motor 202 and other components of the cooling system.

FIG. 6A shows a revised cooling system 500 with respect to the arrangement shown in FIG. 6. As in FIG. 6, the cooling system pump 510 is connected to a radiator, expansion vessel, and/or pressure release device 512. The cooling system pump 510 transfers coolant to a series of flow control devices 513, 514, 515, 516, and 517, and then to various devices including the electric motor 202, the electric inverter 206, a hydraulic (“hyd”) oil cooler 232 for cooling the hydraulic system of the machine, the DC/DC converter 240 and the on-board charger 210. The example of the cooling system 500 illustrated in FIG. 6A includes a specific flow control device 513, 514, 515, 516, and 517 for each of these various devices, so that the flow rate of coolant is controlled individually, for each device or component 202, 206, 232, 240, and 210. Alternatively, the flow rate for these devices or components 202, 206, 232, 240, 210 can be controlled by controlling the output of the cooling system pump 510.

In FIG. 6A, the battery thermal conditioning system 550 is independent from the cooling system 500. Battery coolant is stored in an accumulator 530. Pump 532 is controlled by the battery management system 224, and selectively pumps battery coolant through a battery thermal management device 560, the battery pack 222, and through the battery coolant temperature sensor 334. Thus, the battery thermal conditioning system 550 is separate from the pump 510 of the cooling system 500. The battery thermal management device 560 maintains the vehicle battery pack 222 within a critical operating temperature range. In one example, the battery thermal management device 560 includes a radiator and a condenser. The battery thermal management device 560 is configured to heat the battery coolant as needed and to cool the battery coolant by operating at a refrigeration cycle. In one example, the battery thermal management device 560 is free from an air-heat exchanger entirely.

FIG. 6B shows another example of a revised cooling system 500. The cooling system 500 for the horizontal directional drilling machine 8 includes an electrical cooling system 500a having a cooling system pump 510 for the basic horizontal directional drilling machine. Pump 510 is connected to a radiator, expansion vessel, and/or pressure release device 512. The pump 510 transferring coolant to a series of flow control devices 513, 514, 516, and 517, and then to various devices including the electric motor 202, the electric inverter 206, the DC/DC converter 240 and the on-board charger 210. Alternatively, the flow rate for these devices or components 202, 206, 240, 210 can be controlled by controlling the output of the pump 510.

In FIG. 6B, the cooling system 500 includes three independent and separate cooling systems. The battery thermal conditioning system 550 is independent and separate from the electrical cooling system 500a. Battery coolant is stored in an accumulator 530. Pump 532 is controlled by the battery management system 224, and selectively pumps battery coolant through a battery thermal management device 560, the battery pack 222, and through the battery coolant temperature sensor 334. The battery thermal management device 560 maintains the vehicle battery pack 222 within a critical operating temperature range. The battery thermal management device 560 is configured to heat the battery coolant as needed and to cool the battery coolant by operating an air-to-liquid heat exchanger or operating at a refrigeration cycle.

FIG. 6B also shows a hydraulic cooling system 570 that is separate and independent from the electrical cooling system 500a and the battery thermal conditioning system 550. The hydraulic cooling system 570 includes a hydraulic oil fluid temperature sensor 572 and a hydraulic tank 574 that contains hydraulic oil fluid. A hydraulic cooling pump 578 pumps hydraulic fluid from the hydraulic tank 574 for hydraulic operations 580. The hydraulic operations 580 include the functions of the ground drive motor 12, spindle 22, rotary drive motor for the drill 24 and the carriage 30. Thereafter the hydraulic oil fluid is provided to a hydraulic cooler 232. From the hydraulic cooler 232, the hydraulic oil fluid is returned to the hydraulic tank 574. The hydraulic oil cooler 232 cools the hydraulic system 100. In one example, the hydraulic cooling pump 578 provides fluid only to the hydraulic cooler 232. In other examples, one or more of the hydraulic pumps 14, 34, 44, 578 provide the hydraulic fluid to the hydraulic cooler 232. Other arrangements are contemplated.

In the FIG. 6B arrangement there is no heat transfer between the hydraulic fluid of the hydraulic system 100 of the machine and the coolant of electrical cooling system 500a. Further, the electrical cooling system 500a, the battery thermal conditioning system 550, and the hydraulic cooling system 570 are separate from each other and there is not heat transfer therebetween.

The electric drive system 200 of the horizontal directional drilling machine 8 is intended to be configured for flexible operations including:
if power required by the horizontal directional drilling machine is less than 40 kW, then the on-board charger 210 has the capacity to provide all the power required by the machine, plus providing power to charge the battery pack 222;
if power required by the machine for optimizing its performance is more than 40 kW, then the electric drive system 200 draws power from the on-board charger 210 and the battery pack 222 simultaneously, at least as long as the energy stored in the battery pack 222 is within an acceptable range;
if there is a limit on the amount of power that can be drawn from the off-board power supply, such as the 400V AC line power supply 400 or the 400V AC generator 402 shown in FIG. 1, that is less than 40 kW, then the electric drive system 200 is controlled in a way that a maximum power draw from the off-board power system can be controlled. The control system 300 is configured to make continuous adjustments:
at times power to operate the drill is provided from both the off-board power source or supply 400, 402, 404, through the on-board charger 210 and the on-board battery pack 222;
at times power to operate the drill is provided from the off-board power source or supply 400, 402, 404 through the on-board charger 210 to power the drill and other devices, while power is simultaneously being drawn from the off-board power source or supply, through the on-board charger 210 to charge the on-board battery pack 222; and
at times power to operate the drill is provided exclusively by the on-board battery pack 222.

Interactions between the system controller 308 in FIG. 1 or the machine controller 302 in FIG. 3 [hereinafter, the “controller” 302 (FIG. 3 example), 308 (FIG. 1 example)], and the other components/controllers of the horizontal directional drilling machine 8 includes: interaction between the controller 302, 308 and the battery management system 224, and the controller 302, 308 sending a request to the battery management system 224 for charge and discharge state. This is the only information sent to the battery management system 224. The battery management system 224 reports back voltage, currents, temperatures, battery SoC (state of charge), and status of the battery pack 222 to the controller.

The controller 302, 308 uses the information from the battery management system 224 to monitor the battery management system and to control the cooling system 500 (flow and fan speed). In controlling the cooling system 500, in one example the controller 302, 308 is configured to receive speed, current, and coolant temperature from the electric inverter 206, and the controller is configured to provide coolant to the electric inverter 206 to maintain the electric inverter at a desired temperature. In another example, the controller 302, 308 is configured to receive speed, current, and coolant temperature from the electric motor 202, and the controller is configured to provide coolant to the electric motor 202 to maintain the electric motor at a desired temperature. In another example, the controller 302, 308 is configured to receive via the communication bus 306 a coolant temperature/internal temperature, current in/out values, and voltage in/out values from a DC/DC converter 240 of the battery system 220, and the controller is configured to communicate with the cooling system 500 to provide coolant to the DC/DC converter 240, 250 to maintain the DC/DC converter at a desired temperature. The controller 302, 308 also transmits voltage and current control commands to the DC/DC converter via the communication bus 306.

The controller 302, 308 is also configured for interaction between the controller and the on-board charger 210. The controller 302, 308 sends a request to the on-board charger 210 to start converting AC power to DC power and sets an output current value that is desired. The on-board charger 210 operates to output the current setpoint at the voltage of the DC power bus 208. The battery SoC determines the DC voltage and will absorb the “extra” current from the on-board charger 210 or chargers, if the electric drive system 200 has more than one on-board charger 210.

In an alternative example, not shown in any of the figures, if the drilling system 8 does not have a battery pack 222, if the battery pack is not functioning or is not connected to the DC power bus 208, the controller 302, 308 includes a control loop or algorithm to regulate the DC voltage provided to the electric inverter 206, by control of the on-board charger 210.

The controller 302, 308 is also configured for interaction with the electric inverter 206. The controller 302, 308 sends a request to the electric inverter 206 to start spinning the electric motor 202 at a time that is appropriate, based on how the machine's operator controls 304 are being utilized by an operator. In one example, the controller 302, 308 will provide a requested speed setpoint for the electric motor output shaft 204. The electric inverter 206 has adjustable power limits. In another example, the controller 302, 308 will provide desired power targets as may be appropriate for meeting the power requirements of specific operations of the hydraulic system 100.

In another example, the controller 302, 308 communicates with the electric inverter 206. The electric inverter 206 will report back speed, current, coolant temperatures, etc. to the controller via the communication bus 306. The controller 302, 308 is configured to use that information to monitor the electric drive system 200 and to control the cooling system 500.

The controller 302, 308 is configured to use the data from the electric inverter 206 to determine how to control the on-board charger 210. In one example, the controller 302, 308 receives the reported current value delivered to the electric inverter 206, and sets the output current setpoint for the on-board charger 210 accordingly.

Logic for the controller 302, 308 controlling the on-board charger 210 is as follows. The battery pack 222 is electrically connected to the DC power bus 208 unless there is a fault with the DC power bus 208 determined by the controller using the insulation monitoring device 330 or the battery coolant temperature sensor 334 has a fault determined by the battery management system 224. This arrangement allows the battery pack 222 to charge and discharge.

The controller 302, 308 utilizes the battery voltage received from the battery management system 224 to determine the DC bus voltage. The controller 302, 308 also provides an on-board charger current setpoint to the on-board charger 210 that is based on the current consumption of the electric inverter 206, the output currents of the DC/DC converter 240, 250, and the battery state-of-charge (SoC).

When the battery SoC >80%, the controller 302, 308 will set the on-board charger 210 to the required drive current plus inverter current. When the battery SoC <80%, the controller 302, 308 is configured to set the on-board charger 210 to the required drive current and inverter current, plus charging current.

In instances when the controller 302, 308 requires quick power demands for the horizontal directional drilling machine 8, the battery pack 222 supplements the on-board charger(s) 210 until the charger outputs are increased via commands from the controller over the communication bus 306.

While a communication bus 306 such as a CAN bus is disclosed and shown, other types of connection buses or other arrangements are contemplated that include wireless communication arrangements.

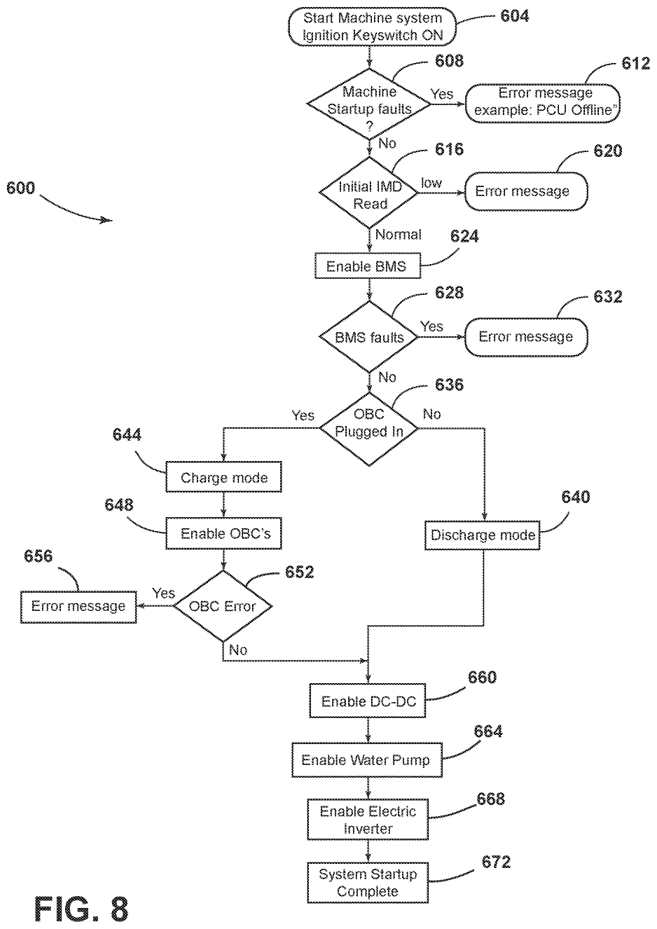

Use of the controller 302, 308 for assisting in the operation of the horizontal directional drilling machine 8 is further described in the examples set forth in the flowcharts shown FIGS. 8-10 as follows.

FIG. 8 is a flowchart 600 that illustrates start-up of the horizontal directional drilling machine 8 upon use of the key switch or the like at step 604. Upon start-up, the controller 302, 308 determines start-up faults at step 608. In the event of start-up faults, the controller advances to step 612 and provides an error message to an operator, such as “PCU Offline.” When no start-up fault occurs, the controller 302, 308 advances to decision step 616.

At decision step 616 in FIG. 8, the controller 302, 308 obtains the output of the insulation monitoring device 330 via the communication bus 306. The controller 302, 308 determines from the value obtained from the insulation monitoring device 330 whether a fault exists for the DC power bus 208. If there is a fault at decision step 616, the controller 302, 308 advances to step 620 and provides an error message regarding a short circuit of the DC power bus 208 to a display to the operator of the horizontal directional drilling machine 8. Further, the battery pack 222 is disabled from providing power to the DC power bus 208. When there is no fault at decision step 616, the controller 302, 308 advances to step 624.

At step 624, the controller 302, 308 permits enabling of the battery management system 224 of the battery system 220. Thereafter, the controller advances to decision step 628.

At decision step 628, the controller 302, 308 communicates with the battery management system 224 over the communication bus 306 as to whether there are faults determined by the battery management system. If faults are received, the controller 302, 308 advances to step 632. At step 632, the controller provides an error message on a display to the operator of the horizontal directional drilling machine 8. In some examples, an audio signal is provided as well as, or instead of a visual message. In the event a battery management system fault is not determined at step 628, the controller 302, 308 advances to decision step 636.

At decision step 636, the controller 302, 308 communicates over the communication bus 306 with the electric inverter 206. The electric inverter 206 provides a voltage signal or power signal to the controller 302, 308 as to whether the on-board charger 210 is providing a DC voltage output from line power or a generator. When the controller 302, 308 determines that the horizontal directional drilling machine 8 has no external AC connection at decision step 636, the controller advances to step 640. At step 640, the controller 302, 308 operates the horizontal directional drilling machine 8 including the drill in discharge mode. Thus, the battery pack 222 provides power to the hydraulic system 100 without assistance.

When the controller 302, 308 determines at decision step 636 that the electric inverter 206 is receiving external power from an external AC connection connected to the on-board charger 210, the controller advances to step 644. At step 644, the controller 302, 308 enables or controls operation of the on-board charger 210 to provide proper voltage/power to the electric inverter 206 for powering the horizontal directional drilling machine 8, for powering the DC/DC converters 240, 250, and for recharging the battery pack 222 when battery charging is needed.

From step 644, the controller 302, 308 advances to step 648 to enable/control the voltage supplied by the on-board charger(s) 210 in response to a control signal sent thereto via the communication bus 306.

After step 648, the controller 302, 308 advances to on-board charger error decision step 652. At decision step 652, if the controller determines that there is an error for the on-board charger, the controller decides to advance to step 656. At step 656, the controller 302, 308 outputs an error message that the on-board charger 210 is not operating properly.

When there is no error for the on-board charger 210, the controller 302, 308 advances to step 660 in the charge mode. When no charge is provided in discharge mode at step 640 with no on-board charger plugged in, the controller 302, 308 advances to same step 660 in the discharge mode.

At step 660, the controller 302, 308 enables operation of the DC/DC converters 240, 250 that provide power to various devices of the horizontal directional drilling machine 8. The controller 302, 308 then advances to step 664.

At step 664, the controller 302, 308 enables operation of the pump 510 of the cooling system 500. The controller advances to step 668 and enables operation of the electric inverter 206 to provide power to the horizontal directional drilling machine 8. The controller 302, 308 advances to step 672 whereat system startup is complete and operation of the horizontal directional drilling machine 8 by operating the operator controls 304 is available.

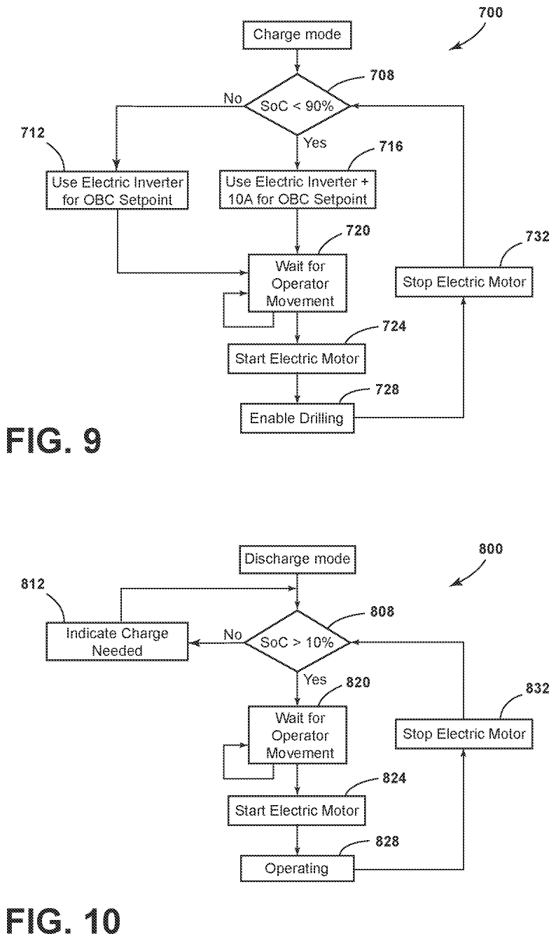

Upon completion of the system startup as shown in FIG. 4, the controller advances to the charge mode shown in the flowchart of FIG. 9, when the charge mode was determined at steps 636, 644 in FIG. 8.

In the charge mode of operation shown in FIG. 9, at decision step 708, the controller 302, 308 determines whether or not the state of charge of the battery pack 222 is less than 90%. If not less than 90%, the controller 302, 308 executes and advances to step 712. While a value of 90% is contemplated, other values for the state of charge in a range from 80% to 95% are also contemplated.

At step 712, the controller 302, 308 sets an on-board current setpoint that is sent over the communication bus 306 to the on-board charger 210 to provide a proper on-board controller setpoint so that the on-board chargers provide a proper current value to the electric inverter 206. The controller 302, 308 then advances to step 720.

Returning to decision step 708, when the state-of-charge is less than 90% of an optimum desired value, the controller 302, 308 executes a charge mode program by advancing to step 716. At step 716, the controller 302, 308 provides an on-board charger set point so that the on-board charger 210 provides a proper current value to the electric inverter 206, along with additional current, such as 10 amps in one example, that is provided over the DC power bus 208 to the battery system 220 for charging the battery pack 222. Thus, charging of the battery pack 222 occurs. Thereafter, the controller 302, 308 advances to step 720.

At step 720, the controller 302, 308 waits for operator movement or use of the operator controls 304. As shown in FIG. 9, when no control occurs, the controller 302, 308 continues to delay waiting for operation of the horizontal directional drilling machine 8. Upon movement of the operator controls 304, the controller 302, 308 advances to step 724. In some instances, such as cold weather, the electric motor 202 is operated so that the hydraulic system 100 is at a desired minimum temperature.

At step 724, the controller 302, 308 controls the electric inverter 206 to provide current to start and power the electric motor 202. Thus, the selected controls operate the horizontal directional drilling machine 8. Thereafter, the controller 302, 308 advances to step 728.

At step 728, drilling by the horizontal directional drilling machine 8 occurs when selected by the operator controls 304. Further, movement of the tracks 10 of the horizontal directional drilling machine 8 can be selected, as well as adding pipe by utilizing the carriage 30, operating a mud pump or other operations thereof (not shown). During this operation, the controller 302, 308 is configured and capable of executing additional programs or routines in some examples. Such examples include continuously monitoring insulation of the DC power bus 208 with the insulation monitoring device 330, battery pack temperature with the battery coolant temperature sensor 334, state-of-charge of the battery pack 222, along with the user inputs.

During the enable drilling step 728 or enabling of other functions of the horizontal directional drilling machine 8, in one example when no input from the operator controls 304 for a predetermined or selected time period passes without any operator control, the controller 302, 308 advances to step 732.

At step 732, the controller 302, 308 is configured to provide an output signal to the electric inverter 206 to discontinue the supply of power from the electric inverter 206 to the electric motor 202. In one example, the controller 302, 308 also provides a signal to the on-board charger 210 to reduce the current output therefrom to the DC power bus 208 or eliminate the current output by the on-board charger to the DC power bus 208 when the battery pack 222 is completely charged.

After step 732, the controller 302, 308 advances to step 708 and determines the state-of-charge of the battery pack 222 and continues to operate.

When the drill of the horizontal directional drilling machine 8 is connected to an AC power source, and the power needed is greater than a predetermined amount, such as 44 kW in one example, the battery pack 222 automatically and directly supplies additional power to the electric inverter 206 via the DC power bus 208. The controller 302, 308 is also configured to enable peak-shaving of the outputs as necessary.

Returning to FIG. 8, when the system start-up is complete at step 672, and the discharge mode was previously selected at step 640, the controller 302, 308 advances to the discharge mode shown in the flowchart 800 of FIG. 10.

In the discharge mode of operation shown in FIG. 10, at decision step 808, the controller 302, 308 determines whether or not the state-of-charge of the battery pack 222 is greater than 10%. If not greater than 10%, the controller 302, 308 executes and advances to step 812. At step 812, the controller provides an audible and/or visual indication to an operator of the horizontal directional drilling machine 8 that the battery pack 222 is not sufficiently charged for operation. Thereafter, no operation of the horizontal directional drilling machine 8 is allowed by the controller 302, 308 until sufficient charging of the battery pack occurs.

Returning to decision step 808, when the state-of-charge of the battery pack 222 is greater than 10% of the maximum state-of-charge, the controller 302, 308 executing the program or routine illustrated by flowchart 800 advances to step 820.

At step 820, the controller 302, 308 waits for operator movement or use of the operator controls 304. As shown in FIG. 10, when no control occurs, the controller 302, 308 continues to delay waiting for operation of the horizontal directional drilling machine 8. Upon movement of the operator controls 304, the controller 302, 308 advances to step 824.

At step 824, the controller 302, 308 controls the electric inverter 206 to provide current from the battery pack 222 to start and power the electric motor 202. Thus, the selected controls are able to operate the horizontal directional drilling machine 8. Thereafter, the controller 302, 308 advances to step 828.

At step 828, drilling by the horizontal directional drilling machine 8 occurs when selected by the operator controls 304. Further, movement of the tracks 10 of the horizontal directional drilling machine 8 can be selected, as well as adding pipe by utilizing the carriage 30, operating a mud pump or other operations thereof (not shown). During this operation, the controller 302, 308 executes additional programs or routines in some examples. Such examples include continuously monitoring insulation of the DC power bus 208 with the insulation monitoring device 330, battery pack temperature with the battery coolant temperature sensor 334, state-of-charge of the battery pack 222, along with sensing the user inputs to control devices.

During the operating step 728 for enabling functions of the horizontal directional drilling machine 8, in one example when no input from the operator controls 304 for a predetermined or selected time period, such as one minute, passes without any use of the operator controls 304, the controller 302, 308 advances to step 832.

At step 832, the controller 302, 308 provides an output signal to the electric inverter 206 to discontinue the supply of power from the electric inverter 206 to the electric motor 202.

After step 832, the controller 302, 308 advances to decision step 808 and determines the state-of-charge of the battery pack 222 and continues to advance to step 820, so long as the state-of-charge is greater than 10% of the desired full charge for the battery pack 222. While 10% is selected for the state-of-charge in FIG. 10, other state-of-charge values in a range between 5% and 20% are contemplated.

While the controller 302, 308 performing the steps set forth in FIGS. 8-10 and elsewhere is considered to be a single electronic controller performing the functions and steps detailed therein, in some examples, multiple electronic controllers 302, 308, 380 perform various controller functions. Further, the electronic processor 310 corresponding to any one of the controllers 302, 308, 380 includes multiple electronic processors 310 in some examples. Although various methods and processes have been described as being carried out by an electronic processor 310 in a particular order, in some cases the methods and processes are carried out in a different order.

In one example, coolant temperature sensors are provided for each of the devices that receive coolant. Such devices include, but are not limited to the electric inverter 206, the on-board charger 210, the electric motor 202, the ground drive motor 12, the rotary drive 20, the thrust/pullback motor 32, and the battery pack 222.

In addition, unless the context of their usage unambiguously indicates otherwise, the articles “a” and “an” should not be interpreted as meaning “one” or “only one.” Rather these articles should be interpreted as meaning “at least one” or “one or more.”

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if examples described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

Although certain embodiments, examples, features, and aspects have been described and illustrated, variations and modifications exist within the scope and spirit of the subject matter explained and shown.

1. A control system for a horizontal directional drilling machine, the control system comprising:
an electric drive system including an on-board charger and an electric inverter for providing current to an electric motor;
a hydraulic system including an input shaft driven by the electric motor, the input shaft arranged to drive a spindle for a drill, and a carriage;
a battery system including a battery pack and a battery management system;
a cooling system including a pump, and a temperature sensor; and
a controller configured to:
control the on-board charger to provide an on-board current setpoint for the on-board charger to provide current to the electric inverter in response to data received from the electric inverter and a state-of-charge and a status of the battery pack; and
control the electric inverter to drive the electric motor.

2. The control system of claim 1, wherein the controller is configured to receive speed, current, and coolant temperature from the electric inverter, and the controller is configured to provide coolant to the electric inverter to maintain the electric inverter at a desired temperature, and wherein the cooling system includes flow control devices.

3. The control system of claim 1, wherein the controller is configured to receive speed, current, and coolant temperature from the electric motor, and the controller is configured to provide coolant to the electric motor to maintain the electric motor at a desired temperature, wherein the coolant for the electric motor is separate from a battery coolant for the battery pack.

4. The control system of claim 3, wherein a heat exchanger exchanges heat between the battery coolant and the coolant for the electric motor.

5. The control system of claim 1, wherein the temperature sensor is a hydraulic oil fluid temperature sensor, wherein the controller is configured to receive a coolant temperature from the hydraulic oil fluid temperature sensor of the cooling system, wherein the cooling system is a hydraulic cooling system that includes the hydraulic oil fluid temperature sensor, a hydraulic cooler, and the pump is a hydraulic cooling pump to provide hydraulic oil fluid to the hydraulic cooler, and wherein a battery thermal conditioning system includes a pump that selectively pumps battery coolant through a battery thermal management device, a battery pack, and a battery coolant temperature sensor, and wherein the battery thermal management device is configured to heat or cool the battery coolant to maintain the battery pack within an operating temperature range.

6. The control system of claim 5, wherein the battery system includes a pump for the battery coolant that is separate from the pump of the cooling system.

7. The control system of claim 1, wherein the controller is a system controller in communication with a machine controller, wherein the system controller, the machine controller, the battery management system, the on-board charger, and the electric inverter are connected by a communication bus.

8. The control system of claim 1, wherein the controller is a machine controller configured to control the hydraulic system including hydraulic pumps for operating the drill and for operating a ground drive motor.

9. The control system of claim 8, wherein a pump controller is provided in communication with the machine controller to control the hydraulic system, and wherein the input shaft driven by the electric motor is the input shaft of a pump drive connected to the hydraulic pumps.

10. (canceled)

11. The control system of claim 1, wherein the controller is configured to control the cooling system to provide cooling/heating flow for a battery coolant to the battery pack of the battery system in response to voltage, current, battery coolant temperature, battery state-of-charge, and status of the battery pack received from the battery management system.

12. (canceled)

13. A horizontal directional drilling machine comprising:
an electric drive system including an on-board charger and an electric inverter for providing current to an electric motor;
a hydraulic system including an input shaft driven by the electric motor, the input shaft arranged to drive a spindle for a drill, and a carriage;
a battery system including a battery pack and a battery management system;
a cooling system including a pump, and a temperature sensor; and
a control system including a controller configured to:
control the on-board charger to provide an on-board current setpoint for the on-board charger to provide current to the electric inverter in response to data received from the electric inverter and a state-of-charge and a status of the battery pack; and
control the electric inverter to drive the electric motor.

14. The drilling machine of claim 13, wherein the controller is configured to receive speed, current, and coolant temperatures from the electric inverter, and the controller is configured to provide coolant to the electric inverter to maintain the electric inverter at a desired temperature, and wherein the cooling system includes flow control devices.

15. The drilling machine of claim 13, wherein the controller is configured to receive speed, current, and coolant temperature from the electric motor, and the controller is configured to provide coolant to the electric motor to maintain the electric motor at a desired temperature, wherein the coolant for the electric motor is separate from the battery coolant for the battery pack, and wherein a heat exchanger exchanges heat between the battery coolant and the coolant for the electric motor.

16. (canceled)

17. The drilling machine of claim 13, wherein the temperature sensor is a hydraulic oil fluid temperature sensor, wherein the controller is configured to receive a coolant temperature from the hydraulic oil fluid temperature sensor of the cooling system, wherein the cooling system is a hydraulic cooling system that includes the hydraulic oil fluid temperature sensor, a hydraulic cooler, and the pump is a hydraulic cooling pump to provide hydraulic oil fluid to the hydraulic cooler, and wherein a battery thermal conditioning system includes a pump that selectively pumps battery coolant through a batter thermal management device, a battery pack, and a battery coolant temperature sensor, and wherein the battery thermal management device is configured to heat or cool the battery coolant to maintain the battery pack within an operating temperature range, and wherein the battery system includes a pump for the battery coolant that is separate from the pump of the cooling system.

18-21. (canceled)

22. The drilling machine of claim 13, wherein the on-board charger is a first on-board charger and the electric drive system includes a second on-board charger; and
wherein the electric inverter is a first electric inverter, and the electric drive system includes a second electric inverter.

23. The drilling machine of claim 13, including a battery thermal conditioning system that is separate from the cooling system of the drilling machine, wherein the battery thermal conditioning system includes a battery thermal management device that includes a refrigeration cycle for cooling battery coolant.

24. (canceled)

25. The drilling machine of claim 13, wherein the cooling system includes:
an electrical cooling system including the pump, the coolant temperature sensor, and the flow control devices;
a battery thermal conditioning system that includes a battery thermal management device; and
a hydraulic cooling system that includes a hydraulic cooler,
wherein the electrical cooling system, the battery thermal conditioning system, and the hydraulic cooling system are separate from each other and there is not heat transfer therebetween.

26. The drilling machine of claim 25, wherein the electrical cooling system operates for cooling the electric motor, the electric inverter, and the on-board charger.

27. The drilling machine of claim 13, wherein the hydraulic system includes a hydraulic mud pump motor for driving a mud pump.

28. The drilling machine of claim 13, wherein the electric drive system includes a second electric inverter connected to a second electric motor for powering a mud pump.
